(19) United States
(12) Patent Application Publication
(10) Pub. No.: US 2010/0015333 A1
(43) Pub. Date: Jan. 21, 2010

(54) SPRAY COATING PROCESS WITH REDUCED GAS TURBULENCE

(75) Inventor: Dave McMorrow, Galway (IE)

Correspondence Address: KENYON & KENYON LLP, 1500 K STREET N.W., SUITE 700, WASHINGTON, DC, 20005, US

(73) Assignee: BOSTON SCIENTIFIC SCIMED, INC., Maple Grove, MN (US)

(21) Appl. No.: 12/498,796

(22) Filed: Jul. 7, 2009

Related U.S. Application Data
(60) Provisional application No. 61/080,819, filed on Jul. 15, 2008.

(51) Int. Cl. B05D 1/02; B05C 11/00

(52) U.S. Cl. 427/248.1; 118/728; 118/692

(57) ABSTRACT

A spray coating apparatus in which gas turbulence is reduced to provide a better controlled spray coating process. The spray coating apparatus comprises a coating chamber, a spray nozzle, and an article holder for holding the article to be coated. Waste gaseous materials generated during the spray coating are extracted through an extraction port on the coating chamber. The amount of extraneous gas flow entering the coating chamber is limited to reduce the amount of gas turbulence in the coating chamber. Also disclosed is a method of spray coating with reduced gas turbulence.

### CROSS REFERENCE TO RELATED APPLICATION

The present application claims priority to U.S. provisional application Ser. No. 61/080,819 filed Jul. 15, 2008, the disclosure of which is incorporated herein by reference in its entirety.

### TECHNICAL FIELD

The present invention relates to the spray coating of medical devices.

### BACKGROUND

Many implantable medical devices, such as coronary artery stents, are coated with a therapeutic agent to increase the effectiveness of the device. One way in which the coating can be applied to the medical device is by spray coating. However, in many cases, the spray coating of medical devices involves the use of hazardous solvents. To prevent exposure of personnel to such hazardous solvents, some conventional spray coating processes are performed in sealed chambers in which the hazardous solvents are carried out by HEPA-filtered air that is introduced into the chamber through one or more air inlets at one end and extracted at the other end.

In such cases, there are two separate gas flows in the chamber: a flow of nitrogen gas used for spraying the coating fluid, and a flow of filtered air for extraction of the solvent. This can be problematic because these two separate gas flows can interfere with each other, causing turbulence and aerodynamic instability in the chamber, which make it difficult to apply coatings in a uniform manner. Therefore, there is a need for a spray coating process in which gas turbulence is reduced.

### SUMMARY

In one aspect, the present invention provides a spray coating apparatus comprising: a coating chamber having an extraction port for extracting gaseous material in the coating chamber; an article holder for holding an article within the coating chamber; and one or more spray nozzles for introducing a coating fluid into the chamber and for providing a gas stream for spraying the coating fluid; wherein at least a substantial majority of the gaseous material extracted through the extraction port is provided by the one or more spray nozzles.

In another aspect, the present invention provides a method of spray coating an article, comprising: placing an article to be spray coated inside a coating chamber; introducing a coating fluid into the coating chamber; introducing a gas stream into the coating chamber to spray the coating fluid onto the article; and extracting gaseous material contained in the coating chamber; wherein at least a substantial majority of the gaseous material extracted from the coating chamber is provided by the gas stream introduced into the coating chamber to spray the coating fluid.

### BRIEF DESCRIPTION OF THE DRAWINGS

FIG. 1 shows a cross-section side view of a spray coating apparatus according to an embodiment of the present invention.

FIG. 2 shows a perspective view of a spray nozzle tip according to certain embodiments of the present invention.

### DETAILED DESCRIPTION

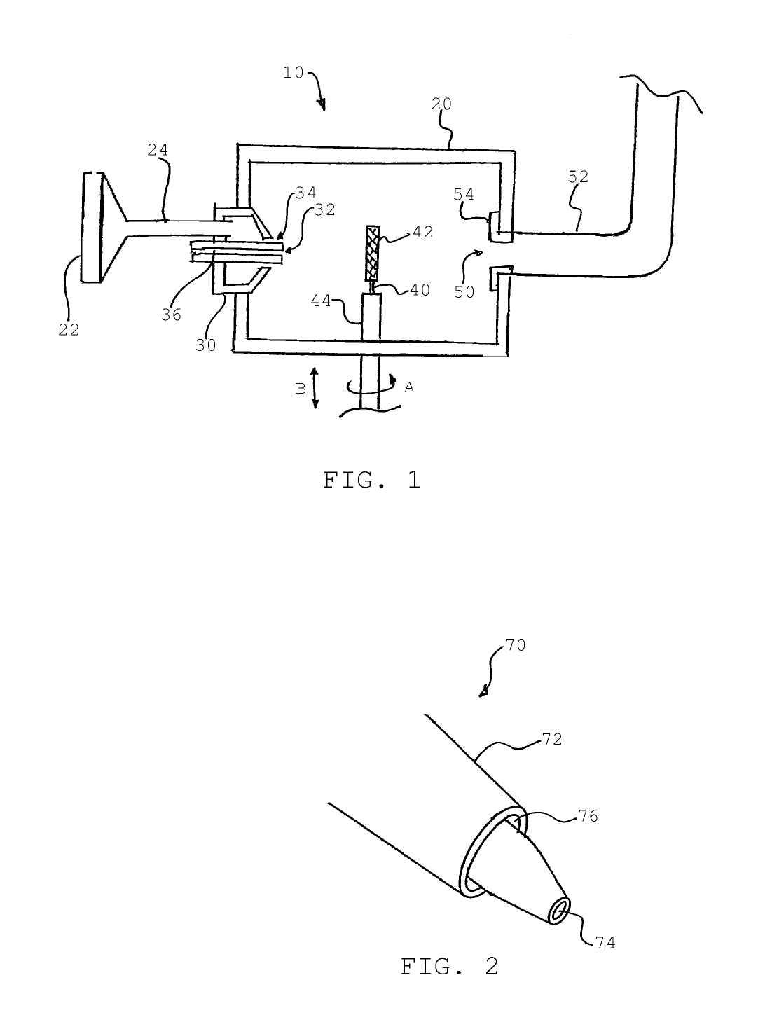

The present invention allows for spray coating an article with reduced gas turbulence to provide a better controlled spray coating process. In one aspect, the present invention provides a spray coating apparatus. An embodiment of such a spray coating apparatus is shown in FIG. 1. In this embodiment, a spray coating apparatus 10 comprises a coating chamber 20, a spray nozzle 30, and a stent holder 40.

Spray nozzle 30 has a coating fluid orifice 32 for dispensing coating fluid. Coating fluid is supplied to spray nozzle 30 from a coating fluid reservoir (not shown). Coating fluid travels from the reservoir, through an internal nozzle passage 36 in spray nozzle 30, and is dispensed out of coating fluid orifice 32.

To spray the coating fluid, spray nozzle 30 also has a gas orifice 34 for ejecting a stream of gas which atomizes and entrains the coating fluid dispensed out of coating fluid orifice 32. The gas for spraying the coating fluid is drawn from room air through a HEPA (high efficiency particulate air) filter 22, travels through a gas supply tubing 24, and is ejected out of gas orifice 34.

In other embodiments, the spray nozzle may be any of various other types of spray nozzles that uses a stream of gas for spray coating fluid. In some cases, in addition to gas streams, the spray nozzle may also employ other spray mechanisms, such as electrostatic potential or ultrasonic vibrations, to spray the coating fluid. Any of various gases conventionally used for spray coating may be used in the present invention, including pressurized nitrogen. One example of a conventional gas-atomizing spray nozzle is shown in FIG. 2, in which the tip 70 of the spray nozzle has a nozzle body 72 and a coating fluid orifice 74. Concentrically around and proximal to coating fluid orifice 74 is an annular-shaped gas orifice 76. As coating fluid is dispensed from coating fluid orifice 74, the annular gas stream from gas orifice 76 creates a low-pressure region that atomizes the coating fluid, which is then entrained in the gas stream.

In the embodiment shown in FIG. 1, spray coating apparatus 10 has a single spray nozzle. By having only a single spray nozzle, the problem of gas flow from one spray nozzle interfering with the spraying by another spray nozzle may be avoided. In other embodiments, however, the spray coating apparatus may have more than one spray nozzle.

Contained within coating chamber 20 is a stent holder 40 which holds a stent 42. To provide control of the spray coating process, stent holder 40 can rotate and/or laterally move stent 42 in relation to spray nozzle 30. In this embodiment, stent holder 40 is connected to a drive mechanism (not shown) via a shaft 44. Shaft 44 is fitted through an opening in coating chamber 20, with the external portion of shaft 44 being connected to the drive mechanism. Torque or force applied on shaft 44 by the drive mechanism causes rotational movement (in the direction of arrow A) and/or translational movement (in the direction of arrow B). In some cases, the opening in coating chamber 20 through which shaft 44 is fitted is tightly sealed to reduce gas leakage.

In alternate embodiments, the drive mechanism for the stent holder does not require a shaft that is inserted through coating chamber 20. In such cases, the drive mechanism for the stent holder may be fully contained inside coating chamber 20. This feature may be useful in avoiding the need to provide an opening in coating chamber 20 for inserting a drive shaft or in reducing the amount of gas leakage in coating chamber 20. For example, the drive mechanism may be battery-operated or be actuated by magnetic coupling with a moving magnetic field from a source that is external to coating chamber 20 (e.g., an externally placed rotating magnet). In other alternate embodiments, the spray coating apparatus does not include any drive mechanism for the stent holder.

During the spray coating process, waste materials (some of which may be hazardous) are generated in coating chamber 20. Such waste materials include gaseous materials such as volatized solvent, air entering through leaks in coating chamber 20, and gas ejected from spray nozzle 30 used to spray the coating fluid. Thus, coating chamber 20 also has an extraction port 50 through which the gaseous materials in coating chamber 20 are extracted. The gaseous materials may be extracted through extraction port 50 using suction, which is created by a suction pump (not shown) via a vent pipe 52 connected to extraction port 50. This suction creates negative pressure inside coating chamber 20 such that room air is drawn through HEPA filter 22 and ejected out of gas orifice 34. While a single extraction port is shown here, in alternate embodiments, coating chamber 20 may have more than one extraction port.

In alternate embodiments, spray coating apparatus 10 may use various other mechanisms for creating a pressure differential to drive the flow of gas from spray nozzle 30 into coating chamber 20 and out of extraction port 50. For example, the gas source for spray nozzle 30 may be pressurized (e.g., from a pressurized nitrogen tank) so that the stream of gas ejected out of spray nozzle 30 creates positive pressure in coating chamber 20. As the pressure inside coating chamber 20 rises above ambient pressure, gaseous materials are driven out through extraction port 50.

The amount of extraneous gas entering coating chamber 20 (i.e., gas that is not used for spraying the coating fluid) is limited to reduce the amount of gas turbulence in coating chamber 20. As such, in the embodiment shown in FIG. 1, coating chamber 20 is tightly sealed such that substantially all of the gaseous material that is extracted through extraction port 50 is provided by spray nozzle 30 (or the plurality of spray nozzles in embodiments where the apparatus has more than one spray nozzle). In alternate embodiments, a small amount of gaseous material entering the chamber may be from other sources (such as leaks or other openings in coating chamber 20, or volatized solvent). As such, in some cases, a substantial majority of the gaseous material that is extracted through extraction port 50 is provided by spray nozzle 30 (or the plurality of spray nozzles in embodiments where the apparatus has more than one spray nozzle). When referring to the amount of gaseous material being extracted that is provided by the spray nozzle(s), a “substantial majority” means that the amount is sufficiently high, relative to that provided by other sources (if any) of gas entry into the chamber, that the other sources of gas entry into the chamber do not significantly interfere with the spraying by the spray nozzle(s). For example, in some cases, at least 75%; and in some cases, at least 90%; and in some cases, at least 95% of the gaseous material that is extracted through extraction port 50 is provided by spray nozzle 30 (or the plurality of spray nozzles in embodiments where the apparatus has more than one spray nozzle).

To control the flow of gaseous material through extraction port 50, the size and/or shape of extraction port 50 is controlled by an adjustable aperture 54 that is fitted around extraction port 50. This feature may be useful in controlling the size and/or shape of the spray plume created by spray nozzle 30. For example, reducing the size of extraction port 50 can reduce the flow of gas being drawn out of gas orifice 34, which can result in a smaller spray plume. By being able to control the size and/or shape of the spray plume, spray efficiency (e.g., the proportion of spray droplets deposited onto the stent) can be optimized. In alternate embodiments, spray coating apparatus 10 does not have an adjustable aperture.

In certain embodiments, spray coating apparatus 10 further comprises one or more gas pressure sensors for monitoring gas pressures at any of various sites in the apparatus. In response to measurements from these gas pressure sensors, gas pressures in spray coating apparatus 10 can be adjusted. For example, a gas pressure sensor may be positioned inside gas supply tubing 24 and another gas pressure sensor may be positioned inside vent pipe 52. These two sensors are in communication with a controller. In response to the sensor measurements, the controller controls adjustable aperture 54 (e.g., by using a servo motor) to change the size and/or shape of extraction port 50. For example, the controller may maintain a constant pressure differential by making automatic adjustments to adjustable aperture 54 in response to changes in the pressure differential as measured by the two sensors, which may be caused by blockages in spray coating apparatus 10 (e.g., caused by dust in HEPA filter 22 or debris in vent pipe 52).

In addition to stents, other type of articles (including other types of medical devices) may be spray coated using the present invention. Non-limiting examples of medical devices that can be spray coated with the present invention include stents, stent grafts, catheters, guide wires, neurovascular aneurysm coils, balloons, filters (e.g., vena cava filters), vascular grafts, intraluminal paving systems, pacemakers, electrodes, leads, defibrillators, joint and bone implants, spinal implants, access ports, intra-aortic balloon pumps, heart valves, sutures, artificial hearts, neurological stimulators, cochlear implants, retinal implants, and other devices that can be used in connection with therapeutic coatings. Such medical devices are implanted or otherwise used in body structures, cavities, or lumens such as the vasculature, gastrointestinal tract, abdomen, peritoneum, airways, esophagus, trachea, colon, rectum, biliary tract, urinary tract, prostate, brain, spine, lung, liver, heart, skeletal muscle, kidney, bladder, intestines, stomach, pancreas, ovary, uterus, cartilage, eye, bone, joints, and the like.

Various types of coating fluids may be used with the present invention, including those having therapeutic agents, which may be any pharmaceutically acceptable agent (such as a pharmaceutical drug), a biomolecule, a small molecule, or cells. Exemplary biomolecules include peptides, polypeptides and proteins; antibodies; oligonucleotides; nucleic acids such as double or single stranded DNA (including naked and cDNA), RNA, antisense nucleic acids such as antisense DNA and RNA, small interfering RNA (siRNA), and ribozymes; genes; carbohydrates; angiogenic factors including growth factors; cell cycle inhibitors; and anti-restenosis agents. Exemplary small molecules include hormones, nucleotides, amino acids, sugars, and lipids and compounds have a molecular weight of less than 100 kD. Exemplary cells include stem cells, progenitor cells, endothelial cells, adult cardiomyocytes, and smooth muscle cells.

The foregoing description and examples have been set forth merely to illustrate the invention and are not intended to be limiting. Each of the disclosed aspects and embodiments of the present invention may be considered individually or in combination with other aspects, embodiments, and variations of the invention. Modifications of the disclosed embodiments incorporating the spirit and substance of the invention may occur to persons skilled in the art and such modifications are within the scope of the present invention, which is limited only by the appended claims.

I claim:

1. A spray coating apparatus comprising:
a coating chamber having an extraction port for extracting gaseous material in the coating chamber;
an article holder for holding an article within the coating chamber; and
one or more spray nozzles for introducing a coating fluid into the chamber and for providing a gas stream for spraying the coating fluid;
wherein at least a substantial majority of the gaseous material extracted through the extraction port is provided by the one or more spray nozzles.

2. The spray coating apparatus of claim 1, wherein the one or more spray nozzles have a coating fluid orifice for dispensing the coating fluid and a gas orifice for providing the gas stream for spraying the coating fluid.

3. The spray coating apparatus of claim 1, wherein substantially all the gaseous material that is extracted through the extraction port is provided by the one or more spray nozzles.

4. The spray coating apparatus of claim 3, wherein the coating chamber is sealed such that substantially all the gas entering the coating chamber is through the one or more spray nozzles.

5. The spray coating apparatus of claim 1, wherein the spray coating apparatus has only a single spray nozzle.

6. The spray coating apparatus of claim 1, wherein the size or shape of the extraction port can be changed.

7. The spray coating apparatus of claim 6, further comprising a gas pressure sensor and a controller in communication with the gas pressure sensor, wherein the controller controls the size or shape of the extraction port in response to signals from the gas pressure sensor.

8. The spray coating apparatus of claim 1, further comprising a mechanism for generating a pressure differential for driving gas out of the spray nozzle and out of the extraction port on the coating chamber.

9. The spray coating apparatus of claim 8, wherein the mechanism comprises a suction pump that is in connection with the extraction port.

10. The spray coating apparatus of claim 8, wherein the mechanism comprises a pressurized gas source that is in connection with the spray nozzle.

11. The spray coating apparatus of claim 1, further comprising a drive mechanism for moving the article holder.

12. The spray coating apparatus of claim 11, wherein the drive mechanism is actuated by magnetic coupling.

13. The spray coating apparatus of claim 1, wherein the article is a stent.

14. A method of spray coating an article, comprising:
placing an article to be spray coated inside a coating chamber;
introducing a coating fluid into the coating chamber;
introducing a gas stream into the coating chamber to spray the coating fluid onto the article; and
extracting gaseous material contained in the coating chamber;
wherein at least a substantial majority of the gaseous material extracted from the coating chamber is provided by the gas stream introduced into the coating chamber to spray the coating fluid.

15. The method of claim 14, wherein the coating fluid and gas stream are introduced into the coating chamber using a spray nozzle.

16. The method of claim 14, wherein substantially all the gaseous material extracted from the coating chamber is provided by the gas stream introduced into the coating chamber to spray the coating fluid.

17. The method of claim 14, further comprising creating a pressure differential to drive the gas stream into the coating chamber and extract gaseous material out of the coating chamber.

18. The method of claim 17, further comprising controlling the extraction of gaseous material to adjust the pressure differential.

19. The method of claim 14, further comprising controlling the extraction of gaseous material to adjust the spraying of the coating fluid onto the article.
